(19) United States
(12) Patent Application Publication
(10) Pub. No.: US 2006/0224481 A1
(43) Pub. Date: Oct. 5, 2006

(54) Method for determining the current value of a future development

(75) Inventors: Brian Lee Boggs, East Peoria, IL (US); Julie Mae Ammon-Balk, Metamora, IL (US); Thomas Jeffrey Richards, Peoria, IL (US); Ulf Johan Lindqwister, Peoria, IL (US); Dennis Raymond Kelly, Morton, IL (US); Bappaditya Banerjee, Peoria, IL (US); Lisa J. Mirande, Bartonville, IL (US); Nigel Graham Smith, Peoria, IL (US); Steven A. Hofstetter, Washington, IL (US); Robert Cook Scott, Washington, IL (US); Kenton Alan Weaver, Burlingame, CA (US); Justin Lee Koch, Deer Creek, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/092,624

(22) Filed: Mar. 30, 2005

(51) Int. Cl. G06Q 40/00

(52) U.S. Cl. 705/35

(57) ABSTRACT

A method for determining the current value of a future development is disclosed. The method includes receiving a set of data corresponding to a plurality of variables associated with the future development and converting the set of data to a financial gain distributed over an estimated production period. The method further includes calculating a net present value of the distributed financial gain to the start of production and risk reducing the net present value of the distributed financial gain according to risks associated with the future development. The method also includes determining a distributed cost of the future development and calculating a net present value of the distributed cost and the risk reduced net present value of the distributed financial gain of the future development.

### TECHNICAL FIELD

This invention relates generally to a method for determining the value of a development and, more particularly, to method for determining the current value of a future development.

### BACKGROUND

The development of new technology requires significant resources. These resources may include personnel, time, materials, facilities, equipment, and other resources known in the art. The availability of these resources may depend on a significant amount of financial investment and may have an associated amount of risk. The companies or other organizations that fund the development of the new technology may desire to know the likelihood of success of the new technology before investing in the new technology

One method that has been developed for estimating the likelihood of commercial success of an intangible asset is described in U.S. Patent Publication No. 2004/0236658 (the '658 publication) of Bowman printed on Nov. 25, 2004. The '658 publication describes a method that includes first defining at least two independent variables that best describe the value of the asset, such as commercial strength and technical strength. The next step involves establishing a series of performance areas and criteria statements that correspond to rating levels probative of the value of the two variables. Each of the independent variables is then assessed according to the performance areas and criteria statements. The results are compiled into a form, summed, and then plotted on an evaluation grid. At the inception of a new idea, the technology is considered to lie at the origin of the evaluation grid. As the idea matures, it follows a trajectory through a “Not Ready” quadrant to one of three other quadrants entitled “Commodity,” “Specialty,” and “Pacesetter.” The higher the trajectory proceeds into the “Pacesetter” quadrant, the more likely it is that there will be a high level of commercial success. The future value of the intangible asset is determined by re-assessing the independent variables using new rating levels based on the likelihood that improvements of the asset can be achieved.

Although the system of the '658 publication may help in allocating investment resources, it only is useful in determining a likelihood of success and does not give any indication of a magnitude of the potential success. Further, the system of the '658 patent does not equate a magnitude of future success to a current financial value for equal comparison among other investment opportunities.

The method of the present disclosure is directed towards overcoming one or more of the problems as set forth above.

### SUMMARY OF THE INVENTION

In accordance with one aspect, the present disclosure is directed toward a method of determining a current value of a future development. The method includes receiving a set of data corresponding to a plurality of variables associated with the future development and converting the set of data to a financial gain distributed over an estimated production period. The method further includes calculating a net present value of the distributed financial gain to the start of production and risk reducing the net present value of the distributed financial gain according to risks associated with the future development. The method also includes determining a distributed cost of the future development and calculating a net present value of the distributed cost and the risk reduced net present value of the distributed financial gain of the future development.

According to another aspect, the present disclosure is directed toward a computer system having a console, at least one input device, and a central processing unit. The central processing unit is configured to convert a set of data corresponding to a plurality of variables associated with the future development to a financial gain distributed over a production period. The central processing unit is also configured to calculate a net present value of the distributed financial gain to the start of production and to risk reduce the net present value of the distributed financial gain according to risks associated with the future development. The central processing unit is further configured to calculate a net present value of a distributed cost of the future development and the risk reduced net present value of the distributed financial gain of the future development.

In accordance with yet another aspect, the present disclosure is directed toward a computer readable medium for use on a computer system. The computer readable medium has computer executable instructions for performing a method including receiving a set of data corresponding to a plurality of variables associated with the future development and converting the set of data to a financial gain distributed over an estimated production period. The method also includes calculating a net present value of the distributed financial gain to the start of production and risk reducing the net present value of the distributed financial gain according to risks associated with the future development. The method further includes determining a distributed cost of the future development and calculating a net present value of the distributed cost and the risk reduced net present value of the distributed financial gain of the future development.

### BRIEF DESCRIPTION OF THE DRAWINGS

FIG. 1 is a timeline illustration of a development process;

FIG. 2 is a block illustration of an exemplary disclosed computer system; and

FIG. 3 is a flowchart illustration of an exemplary disclosed method.

### DETAILED DESCRIPTION

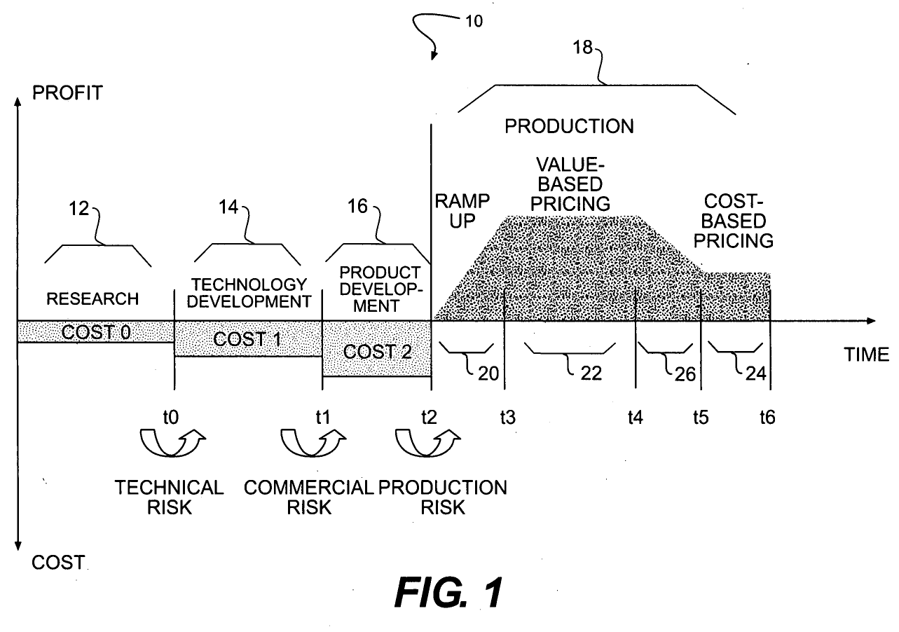

FIG. 1 illustrates a timeline 10 of an exemplary development process. The development process may be used to move a technology from concept through production. In particular, the development process may include a research phase 12, a technology development phase 14, a product development phase 16, and a production phase 18. It is contemplated that additional, fewer, or different phases may alternatively be included in the development process.

As indicated in timeline 10, research phase 12 may be the first or preliminary phase of the development process. During research phase 12, an initial concept may be analyzed and/or modeled to theoretically prove the technical feasibility of the initial concept. Basic proof-of-concept hardware may also be built and lab-tested during this phase of development.

Technology development phase 14 may follow research phase 12. During technology development phase 14, the theoretically proven concept may be matched to the needs of a customer and advanced to a functioning prototype for continued lab and/or initiation of field testing. Extensive business management activities may be undertaken during this phase of development in anticipation of product development and production phases 16, 18, respectively.

Product development phase 16 may come after technology development phase 14. During product development phase 16, the prototypes fabricated during technology development phase 14 may be advanced to customer useable devices that undergo further field testing. During this phase, preparations for production are also undertaken, which may include, among other things, tooling, supplier preparation tasks, marketing, production validation, sales, and distribution preparation tasks.

Once the technology has progressed through product development phase 16, it may be ready for production phase 18. Production phase 18 may include various periods that outline the production life of the developed product from market introduction to replacement by the next emerging technology. In particular, production process 18 may include a ramp-up period 20, where production and/or technical difficulties may be addressed and the new technology becomes known in the market; a value-based pricing period 22, where the difficulties and competition may be low, the technology may be widely recognized, and profit may be at a maximum; a cost-based pricing period 24 where market competition may have increased; and a transition period 26 between value-based pricing period 22 and cost-based pricing period 24, where profit may be declining.

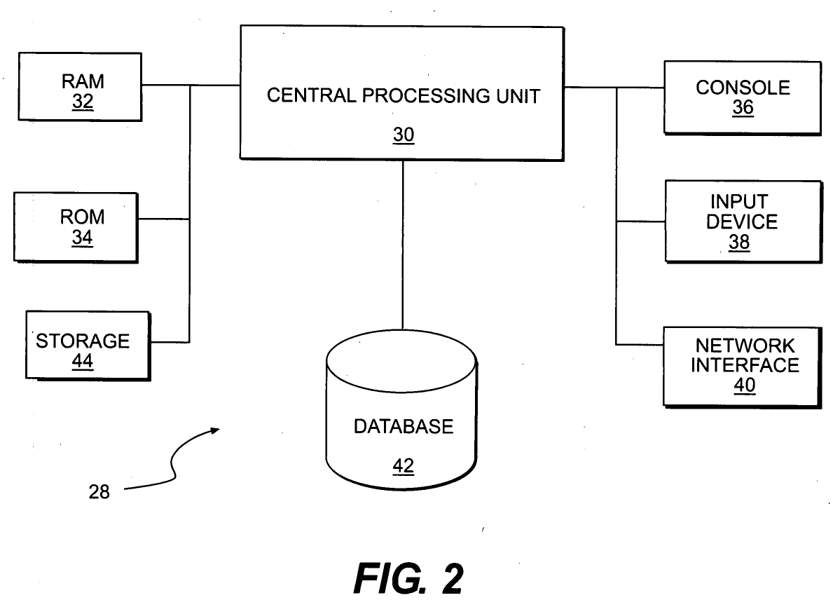

FIG. 2 illustrates a computer system 28 for calculating the value of a product developed under the development process described above. Specifically, computer system 28 may include a central processing unit (CPU) 30, a random access memory (RAM) 32, a read-only memory (ROM) 34, a console 36, an input device 38, a network interface 40, at least one database 42, and a storage 44. It is contemplated that computer system 28 may include additional, fewer, and/or different components than what is listed above. It is understood that the type and number of listed devices are exemplary and not intended to be limiting.

CPU 30 may execute sequences of computer program instructions to perform various processes that will be explained below. The computer program instructions may be loaded into RAM 32 for execution by CPU 30 from ROM 34.

Storage 44 may be any appropriate type of mass storage provided to store any type of information CPU 30 may need to perform the processes. For example, storage 44 may include one or more hard disk devices, optical disk devices, or other storage devices to provide storage space.

Computer system 28 may interface with a user via console 36, input device 38, and network interface 40. In particular, console 36 may provide a graphics user interface (GUI) to display information to users of computer system 28. Console 36 may be any appropriate type of computer display device or computer monitor. Input device 38 may be provided for users to input information into computer system 28. Input device 38 may include, for example, a keyboard, a mouse, or other optical or wireless computer input devices. Further, network interface 40 may provide communication connections such that computer system 28 may be accessed remotely through computer networks.

Database 42 may contain model data and any information related to data records under analysis. Database 42 may also include analysis tools for analyzing the information within database 42. CPU 30 may use database 42 to determine historical relations or trends relating to market share, percent of industry sales (PINS), affect of technology on pricing, and other such pieces of information.

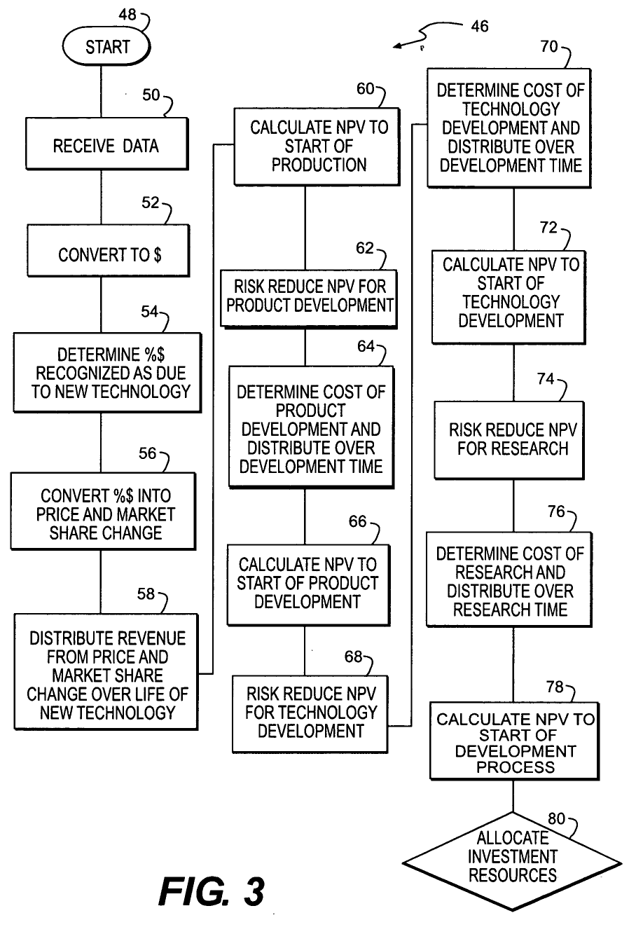

FIG. 3 illustrates a flow chart 46 depicting an exemplary method that utilizes computer system 28 to determine a current value of a future development in preparation for investment resource allocation. It is contemplated that the method may alternatively be implemented manually without the use of computer system 28. The first step after start (step 48) of the method includes receiving data (Step 50). The data may include a set of variables indicative of the functional value of the technology to future owners of the developed product. For example, the set of variables may correlate to how the technology impacts the operation and function of a customer operation and may include, among other things, operator cost information, productivity information, availability information, resale value, average repair cost; fuel consumption, machine purchase price, and other such variables. These variables may be received from inventors, engineers, and other technologists by way of surveys and interviews.

After the data has been received, CPU 30 may convert the set of variables into a financial value (Step 52). In particular, CPU 30 may compare the functional value of the newly gathered set of variables to the functional value for the same set of variables of an existing technology for the life of the technology to determine an amount of financial increase potential for the customer as a direct result of the new technology. CPU 30 may then determine what percent of the financial increase potential is recognizable by the customer as being directly attributable to the new technology (Step 54). The percent of financial increase potential recognizable as directly attributable by the customer to the new technology may be determined by referencing historical data that is associated with past developments and stored within database 42. CPU 30 may then convert this percent of financial increase into an optimum change in price or profit margin increase and a predicted change in sales volume (Step 56), which may be calculated as functions of the existing technology market share.

CPU 30 may determine the value of the new technology at the start of production phase 18. Specifically, CPU 30 may determine a profit to the asset owner from the optimum change in price and the predicted change in sales volume, and distribute this profit throughout ramp-up period 20, value-based pricing period 22, and cost-based pricing period 24 of the new technology production life (Step 58). CPU 30 may then calculate a net present value (NPV) of the profit to the start of production phase 18 (Step 60) using, for example, a discount rate reflective of the cost of capital to the asset owner.

CPU 30 may account for the risk and cost of product development phase 16. In particular, CPU 30 may risk reduce the NPV calculated to the start of production phase 18 to account for the risk of an unsuccessful product development phase 16 (Step 62). The amount of risk reduction may be based on historical averages of past developments that are stored within database 42. CPU 30 may then distribute an estimated cost of product development phase 16 over the product development phase time period (Step 64) and calculate a NPV from the previously calculated NPV and the distributed cost of product development phase 16 to the start of product development phase 16 (Step 66). The cost of product development phase 16 may be estimated by technologists via surveys and/or from historical averages.

CPU 30 may account for the risk and cost of technology development phase 14. In particular, CPU 30 may risk reduce the NPV calculated to the start of product development phase 16 to account for the risk of an unsuccessful adoption of the new technology during technology development phase 14 (Step 68). The amount of risk reduction may be based on technologist input with the use of filters. Filters may include, for example, a survey having one or more questions with discrete, defined, possible responses. The responses may be scored to produce one or more numeric measures representative of different aspects of the associated risk such as, for example, a technical aspect, a commercial aspect, any other such aspect. CPU 30 may then distribute an estimated cost of technology development phase 14 over the technology development phase time period (Step 70) and calculate a NPV from the NPV calculated to the start of product development phase 16 and the distributed cost of technology development phase 14, to the start of technology development phase 14 (Step 72). The cost of technology development phase 14 may be estimated by technologists via surveys and/or from historical averages.

CPU 30 may account for the risk and cost of research phase 12. In particular, CPU 30 may risk reduce the NPV calculated to the start of-technology development phase 14 to account for the risk of an unsuccessful proof-of-concept during research phase 14 (Step 74). The amount of risk reduction may be based on technologist input with the use of filters. CPU 30 may then distribute an estimated cost of technology development phase 14 over the research phase time period (Step 76) and calculate a current NPV from the NPV of technology development phase 14 and the distributed cost of research phase 12, to the start of the development process (Step 78). The cost of research phase 12 may be estimated by technologists via surveys and/or from historical averages.

After the current NPV has been calculated to the start of the development process, asset allocation may be initiated (Step 80). Specifically, the method described above may be completed for multiple technologies to account for potential profit, development costs, time, and risk associated with each of the different technologies. The current NPV can then be used as a means for comparing and ranking the different technologies to determine which of the technologies will be most likely to succeed and will most profit the asset owner.

### INDUSTRIAL APPLICABILITY

The disclosed method and system may provide a way to compare future technologies in preparation for asset allocation. In particular, the disclosed method and systems may be used to determine a current financial value indicative of profit, cost, time, and risk associated with a future investment. In this manner, a potential investor in the new technology may determine not only the likelihood of commercial success, but also the magnitude of the commercial success.

The disclosed method reduces prediction variability by automating the calculation of business results. Specifically, because the disclosed method uses a common set of assumptions and models rather than varying business case assumptions, consistent predictions of commercial effects that reflect the variations in customer value may be produced.

It will be apparent to those skilled in the art that various modifications and variations can be made to the method and system of the present disclosure. Other embodiments of the method and system will be apparent to those skilled in the art from consideration of the specification and practice of the method and system disclosed herein. It is intended that the specification and examples be considered as exemplary only, with a true scope of the disclosure being indicated by the following claims and their equivalents.

What is claimed is:

1. A method for determining a current value of a future development, the method comprising:
receiving a set of data corresponding to a plurality of variables associated with the future development;
converting the set of data to a financial gain distributed over an estimated production period;
calculating a net present value of the distributed financial gain to the start of production;
risk reducing the net present value of the distributed financial gain according to risks associated with the future development;
determining a distributed cost of the future development; and
calculating a net present value of the distributed cost and the risk reduced net present value of the distributed financial gain of the future development.

2. The method of claim 1, wherein:
the future development includes consecutive first and a second development phases;
determining a distributed cost of the future development includes determining a first distributed cost of the second development phase;
risk reducing includes risk reducing the net present value of the distributed financial gain according to risks associated with the second development phase;
calculating a net present value of the distributed cost and the risk reduced distributed financial gain of the future development includes calculating a first net present value of the first distributed cost and the risk reduced distributed financial gain of the future development, to the start of the second development phase; and
the method further includes:
risk reducing the first net present value according to risks associated with the first development phase;
determining a second distributed cost of the first development phase; and
calculating a second net present value of the second distributed cost and the risk reduced first net present value, to the start of the first development phase.

3. The method of claim 2, wherein:
the future development further includes a preliminary development phase;
determining a distributed cost of the future development further includes determining a third distributed cost of the preliminary development phase; and
calculating a net present value of the distributed cost and the financial gain of the future development further includes:
risk reducing the second net present value according to risks associated with the preliminary development phase; and
calculating a current net present value of the third distributed cost and the risk reduced second net present value.

4. The method of claim 1, wherein each of the plurality of variables relates to an operational improvement of the future development over existing technology.

5. The method of claim 4, wherein converting the set of data to a financial gain includes assigning a financial value to each of the operational improvements.

6. The method of claim 5, wherein converting the set of data to a financial gain includes determining what amount of the operational improvements will be attributed to the new technology.

7. The method of claim 6, wherein converting the set of data to a financial gain further includes relating the financial value of the amount of operational improvements attributed to the new technology to a market share increase and a profit margin increase.

8. A computer system, comprising:
a console;
at least one input device; and
a central processing unit configured to:
convert a set of data corresponding to a plurality of variables associated with the future development to a financial gain distributed over a production period;
calculate a net present value of the distributed financial gain to the start of production;
risk reduce the net present value of the distributed financial gain according to risks associated with the future development; and
calculate a net present value of a distributed cost of the future development and the risk reduced net present value of the distributed financial gain of the future development.

9. The computer system of claim 8, wherein:
the future development includes consecutive first and a second development phases;
determining a distributed cost of the future development includes determining a first distributed cost of the second development phase;
risk reducing includes risk reducing the net present value of the distributed financial gain according to risks associated with the second development phase;
calculating a net present value of the distributed cost and the financial gain of the future development includes calculating a first net present value of the first distributed cost and the financial gain of the future development, to the start of the second development phase; and
the central processing unit is further configured to:
risk reduce the first net present value according to risks associated with the second development phase; and
calculate a second net present value of a second distributed cost of the first development phase and the risk reduced first net present value, to the start of the first development phase.

10. The computer system of claim 9, wherein:
the future development further includes a preliminary development phase;
determining a distributed cost of the future development further includes determining a third distributed cost of the preliminary development phase; and
calculating a net present value of the distributed cost and the financial gain of the future development further includes:
risk reducing the second net present value according to risks associated with the preliminary development phase; and
calculating a current net present value of the third distributed cost and the risk reduced second net present value.

11. The computer system of claim 8, wherein the central processing unit is further configured to receive the set of data via the at least one input device, each of the variables being related to operational improvements of the future development over existing technology.

12. The computer system of claim 11, wherein converting the set of data to a financial gain includes assigning a financial value to each of the operational improvements.

13. The computer system of claim 12, further including at least one database, wherein the central processing unit is further configured to determine what amount of the operational improvements will be attributed to the new technology based on historical data stored in the at least one database.

14. The computer system of claim 13, wherein the central processing unit is further configured to relate the financial value of the amount of operational improvements attributed to the new technology to a market share increase and a profit margin increase based on historical data stored within the at least one database.

15. A computer readable medium for use on a computer system, the computer readable medium having computer executable instructions for performing a method comprising:
receiving a set of data corresponding to a plurality of variables associated with the future development;
converting the set of data to a financial gain distributed over an estimated production period;
calculating a net present value of the distributed financial gain to the start of production;
risk reducing the net present value of the distributed financial gain according to risks associated with the future development;
determining a distributed cost of the future development; and
calculating a net present value of the distributed cost and the risk reduced net present value of the distributed financial gain of the future development.

16. The computer readable medium of claim 15, wherein:
the future development includes consecutive first and a second development phases;
determining a distributed cost of the future development includes determining a first distributed cost of the second development phase;
risk reducing includes risk reducing the net present value of the distributed financial gain according to risks associated with the second development phase;
calculating a net present value of the distributed cost and the risk reduced distributed financial gain of the future development includes calculating a first net present value of the first distributed cost and the risk reduced distributed financial gain of the future development, to the start of the second development phase; and
the method further includes:
risk reducing the first net present value according to risks associated with the first development phase;
determining a second distributed cost of the first development phase; and
calculating a second net present value of the second distributed cost and the risk reduced first net present value, to the start of the first development phase.

17. The computer readable medium of claim 16, wherein:
the future development further includes a preliminary development phase;
determining a distributed cost of the future development further includes determining a third distributed cost of the preliminary development phase; and
calculating a net present value of the distributed cost and the financial gain of the future development further includes:
risk reducing the second net present value according to risks associated with the preliminary development phase; and
calculating a current net present value of the third distributed cost and the risk reduced second net present value.

18. The computer readable medium of claim 15, wherein each of the plurality of variables relates to an operational improvement of the future development over existing technology.

19. The computer readable medium of claim 18, wherein converting the set of data to a financial gain includes assigning a financial value to each of the operational improvements.

20. The computer readable medium of claim 19, wherein converting the set of data to a financial gain includes determining what amount of the operational improvements will be attributed to the new technology.

21. The computer readable medium of claim 20, wherein converting the set of data to a financial gain further includes relating the financial value of the amount of operational improvements attributed to the new technology to a market share increase and a profit margin increase.
